(19) United States
(12) Patent Application Publication
(10) Pub. No.: US 2014/0189648 A1
(43) Pub. Date: Jul. 3, 2014

(54) FACILITATED QUALITY TESTING

(71) Applicant: NVIDIA CORPORARTION, Santa Clara, CA (US)

(72) Inventor: Cass Everitt, Austin, TX (US)

(73) Assignee: NVIDIA CORPORATION, Santa Clara, CA (US)

(21) Appl. No.: 13/728,370

(22) Filed: Dec. 27, 2012

(51) Int. Cl. G06F 11/36

(52) U.S. Cl. CPC G06F 11/3668
USPC 717/125

(57) ABSTRACT

Provided is an online application distribution system. The online application distribution system, in this aspect, includes an application reservoir. The online application distribution system, in this aspect, further includes a beta test manager configured to determine if a user associated with the system will participate in beta testing for a beta application in the application reservoir.

### TECHNICAL FIELD

This application is directed, in general, to application (e.g., software) distribution and, more specifically, to application distribution via an online application store.

### BACKGROUND

Online application (e.g., software) stores have become more popular over time. In fact, it is believed that online application stores will be the only readily available mechanism for purchasing applications in the very near future. These stores offer the consumer a larger selection of applications than consumers would find in a traditional store. Consequently, online application stores provide more software developers the opportunity to sell their products.

Unfortunately, a particular implication of more software developers being in the market is that many of them have smaller budgets and less ability to test as broadly as larger, better funded developers. Accordingly, what is needed in the art is an improved method for distributing applications that does not have the drawbacks of existing online application stores.

### SUMMARY

One aspect provides an online application distribution system. The online application distribution system, in this aspect, includes an application reservoir. The online application distribution system, in this aspect, further includes a beta test manager configured to determine if a user associated with the system will participate in beta testing for a beta application in the application reservoir.

Another aspect provides a method of beta testing online distributed applications. The method, in this aspect, includes receiving a beta application to be tested. This method further includes determining potential participants for beta testing the beta application, and sending the beta application over a communications network to at least one beta tester for beta testing, wherein the at least one beta tester is one of the potential participants.

Yet another aspect provides a computer-usable medium having non-transitory computer readable instructions stored thereon for execution by a processor to perform a method for beta testing online applications that are distributed over a communications network. The method, in this embodiment, includes: 1) determining potential participants for beta testing a beta application that is stored in an application reservoir, 2) distributing the beta application over a communications network to at least one beta tester for the beta testing, wherein the at least one beta tester is one of the potential participants, and 3) receiving reporting and diagnostic information about performance of the beta application.

### BRIEF DESCRIPTION

Reference is now made to the following descriptions taken in conjunction with the accompanying drawings, in which:

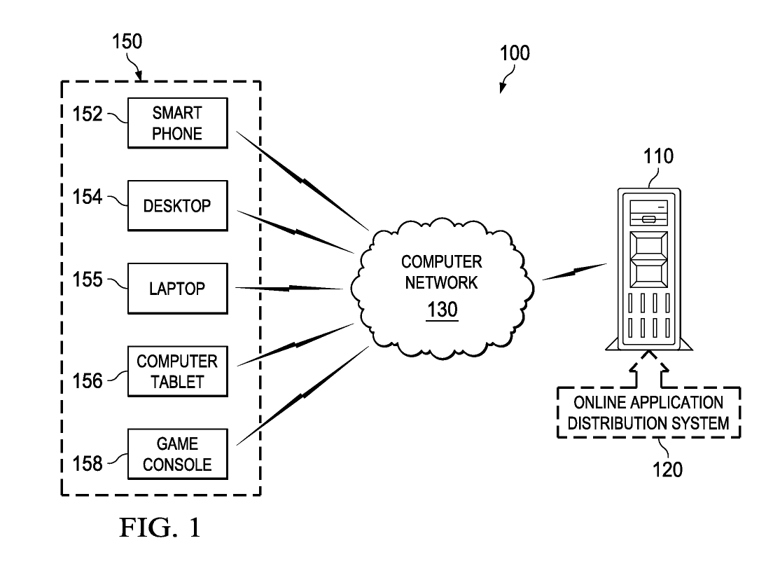

FIG. 1 illustrates a diagram of a computer system that includes an embodiment of an online application distribution system constructed according to the principles of the disclosure;

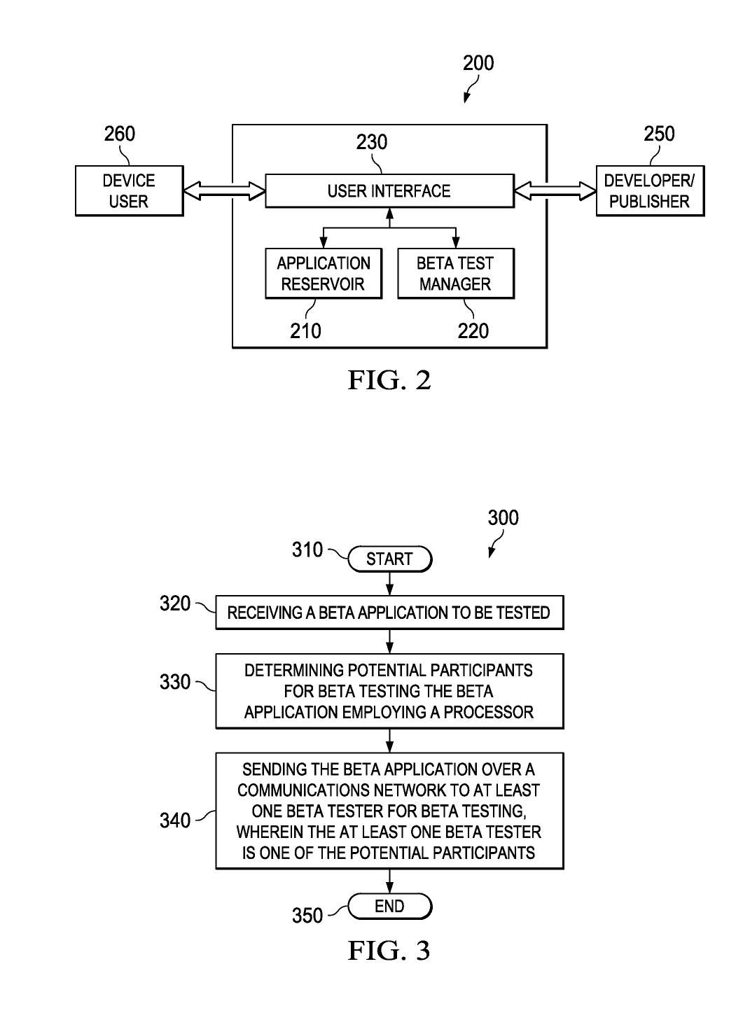

FIG. 2 illustrates a block diagram of an embodiment of an online application distribution system constructed according to the principles of the disclosure; and

FIG. 3 illustrates a flow diagram of an embodiment of a method of beta testing for online distributed applications carried out according to the principles of the disclosure.

### DETAILED DESCRIPTION

The present disclosure is based, at least in part, on the recognition that while online application stores facilitate the inclusion of more applications (e.g., software), the online application stores do not offer mechanisms to facilitate better application testing to keep the quality of the applications high. For example, online application stores currently have no reasonable mechanism for beta testing applications prior to the applications being distributed to the masses. Having the ability to beta test applications via the online application store would greatly improve the quality of the applications being distributed via online application stores, and likely provide a better experience for the user (e.g., consumer) and developer/publisher.

The present disclosure has further recognized that while online application stores are readily able to provide software for download, no existing mechanism currently exists to “roll back” to previous working versions of the application. For example, once a version of an application is published on the online application store, and that version of the application is distributed to one or more users, it is difficult, if not impossible, to roll back to previous versions of the application. Having the capability to easily “roll back” to previous versions of an application using the online application store could alleviate the concerns of users experiencing application glitches—at least until the application developer/publisher has an opportunity to distribute an updated version of the application without the glitches.

With the foregoing recognitions in mind, the present disclosure acknowledges that online applications stores, and those that use them, would benefit greatly if a system and method existed such that users could participate in beta testing of an application via an online application store. The present disclosure acknowledges that a beta test manager could be included within the online application distribution system to address one or more of the issues stated above.

In one example embodiment, the beta test manager could be used to determine if a user associated with the system would participate in beta testing. In one embodiment, the user would agree (or not agree) to participate in the beta testing on an application by application basis. For example, in this embodiment, a user might go to the online application store to request to download a specific application. In the process of attempting to download that specific application, the beta test manager (e.g., via a user interface) might inquire as to whether the user is (or is not) willing to participate in beta testing for that specific application. If the user indicates a willingness to participate in the beta testing, the user would be provided the beta application, as opposed to the non-beta application, for download. If the user indicates an unwillingness to participate in the beta testing, the user would be provided the non-beta application for download.

In another embodiment, the user might globally agree to participate in beta testing. In this embodiment, the user might attempt to download a specific application, and if a beta version of the specific application were available, the user would automatically be provided with the beta application for download. If a beta version of the application did not exist, the user would be provided with the non-beta application for download. In certain examples, the user might be momentarily advised that the application that they are downloading is a beta version of the application.

Another embodiment might exist wherein the beta test manager, for example via the user interface, would independently poll users as to whether they would agree (or not agree) to participate in the beta testing for a particular application. This embodiment differs from the embodiments discussed above, in that the beta test manager is independently polling users, whereas in the embodiments discussed above the user originally reached out to download a specific application. The polling of users, in accordance with this embodiment, might include the beta test manager independently polling all, or a subset, of users already having an older version of the application. In this embodiment, the beta test manager would poll the user of the older version of the application as to whether they would participate in beta testing of a beta application of the older version. If the user indicates a willingness to participate, the beta application would be provided for download (e.g., automatically download in one embodiment). If the user indicates an unwillingness to participate, nothing would occur and the user would be able to continue to enjoy the older version of the application.

Alternatively, the beta test manager might poll users that have expressed a general desire to beta test applications, as opposed to only those that have existing versions of the application. In this example, users of the online application distribution system might indicate to the store that they would be willing to participate in beta testing of a wide range of beta applications. Accordingly, in this embodiment, when a new beta application is published on the online application store, the beta test manager would automatically poll such users as to whether they would be willing to participate in beta testing for the newly published application. Like before, if the user agrees to participate the beta application will be provided for download, if the user does not agree to participate then the beta application will not be provided for download.

The beta test manager, in accordance with one embodiment of the disclosure, is configured to allow users that have previously agreed to participate in beta testing for a beta application to opt out of the beta testing. For example, the users, in this embodiment, are able to opt out of the beta testing for a specific beta application and roll back to their previous version of the application. In this embodiment, when the beta test manager receives a request from a user to opt out of the beta testing, the beta test manager would assist in removing/disabling the beta application from the user's device and installing/enabling a non-beta version of the beta application (e.g., the previous version of the application) on the user's device. In certain situations, the previous version of the application remains on the user's device at the time the beta application is installed. In this scenario, the beta test manager need only help re-enable the previous version. In other situations, the previous version of the application is deleted from the user's device when the beta application is downloaded and installed. In this situation, the beta test manager would assist in the download and installation of the previous version.

Once one or more users agree to participate in beta testing for a specific beta application, and the beta application is downloaded to the user's device, reporting and diagnostic information about the beta application can be generated. The reporting and diagnostic information, as one would expect, would contain extremely valuable information as to glitches in the beta application. For example, the reporting and diagnostic information might contain traditional automatically generated information, such as automatic terminations, what applications were running when the automatic termination occurred, specific configuration of the device, etc. The reporting and diagnostic information might additionally include user specific comments relating to the beta application. While the user specific comments are not statistical in nature, they provide insight into the mind of the user.

The user's device could then transmit, and the beta test manager receive, the reporting and diagnostic information. The beta test manager could then transmit at least a portion, if not all, of the reporting and diagnostic information to the developer/publisher of the beta application. As those skilled in the art appreciate, the developer/publisher of the beta application would likely use that information to correct any issues/glitches in the beta application.

The beta test manager, in certain embodiments, is also configured to allow the developer/publisher to terminate the beta testing of a beta application at any point in time. For example, the developer/publisher may terminate the beta testing if the reporting and diagnostic information indicates the beta application is ready for full deployment. Additionally, the developer/publisher may terminate the beta testing if the reporting and diagnostic information indicates that the beta application is too buggy. Moreover, the termination of the beta testing can be on a global basis, or a more targeted basis. For example, the developer/publisher (e.g., via the beta test manager) might terminate the beta testing for a particular configuration of devices while allowing it to continue for other particular configurations. This scenario would be helpful if one particular device is having problems with the beta application when other particular devices are not.

The beta test manager, in accordance with one embodiment of the disclosure, may be tailored by the developer/publisher. For example, the developer/publisher can tailor the beta test manager to distribute the beta application based upon predetermined guidelines. As one example, the developer/publisher can tailor the beta test manager to filter the distribution of the beta application based upon number of overall downloads for the beta application, device characteristics of the user device attempting to download the beta application, duration of the deployment of the beta testing, any combination of these, etc. The predetermined guidelines are not limited to any specific subset. While there may be certain common guidelines that are easy to filter, other less common guidelines are within the scope of the disclosure. As the developer/publisher can customize the beta test manager, the developer/publisher can create a statistically smart sampling level of those that are allowed to download the beta application.

FIG. 1 illustrates a diagram of a computer system 100 constructed according to the principles of the disclosure. The computer system 100, in the illustrated embodiment, includes a computer 110. In the illustrated embodiment of FIG. 1, the computer 110 is depicted as a server, for example having a processor and memory therein. In alternative embodiments, however, the computer need not comprise a server, and thus could comprise other types of computers including one or more processors and memory.

Residing on, or as a part of, the computer 110 is an online application distribution system 120. In accordance with the disclosure, at least a portion of the online application distribution system 120 can be implemented with the processor of the computer 110. For example, a beta test manager (discussed in detail above and below) can be implemented on the processor of the computer 110.

Coupled via a computer network 130 to the computer 110 embodying the online application distribution system 120 are user devices 150. As those skilled in the art appreciate, the computer network 130 may comprise the internet, as well as a fixed wired or wireless network. Accordingly, the present disclosure should not be limited to any specific computer network 130.

Virtually any type of user device 150 may be coupled via the computer network 130 to the computer 110. FIG. 1 for example, illustrates that a smart phone 152, a desktop 154, a laptop 155, a computer tablet 156 and a game console 158 are coupled, or coupleable, to the computer 110 via the computer network 130. Nevertheless, other types of user devices 150, for example those capable of downloading and running online applications, are within the scope of this disclosure. Accordingly, the computer system 100 should not be limited to any specific user device 150.

FIG. 2 illustrates a block diagram of an embodiment of an online application distribution system 200 constructed according to the principles of the disclosure. The online application distribution system 200, in accordance with one embodiment, includes an application reservoir 210 and a beta test manager 220. While not specifically illustrated, the application reservoir 210 and beta test manager 220 may be coupled, whether directly or indirectly, to one another. Each of the application reservoir 210 and beta test manager 220, in the illustrated embodiment, are coupled to a user interface 230. The user interface 230, as is illustrated in the embodiment of FIG. 2, may be in two way communication with a developer/publisher 250 and a device user 260. The user interface 230, as is illustrated in the embodiment of FIG. 2, may also be in two way communication with the application reservoir 210 and beta test manager 220.

The application reservoir 210, in accordance with the disclosure, may contain a plurality of applications for online distribution. For example, the application reservoir 210 may contain one or more traditional applications for online distribution. The application reservoir 210 may additionally include one or more beta applications for online distribution. Each of the traditional applications and beta applications may be included on the application reservoir 210 from the developer/publisher 250 via the user interface 230.

The beta test manager 220, in accordance with the disclosure and discussed in detail above, may be configured to determine if a user associated with the system 200 will participate in beta testing for a beta application in the application reservoir 210. For example, the beta test manager 220 may communicate with the device user 260 using the user interface 230, and vice versa. As discussed in detail above, certain embodiments exist wherein the device user 260 initiates the contact with the online application distribution system (e.g., including the beta test manager 220) via the user interface 230. Other embodiments exist wherein the beta test manager 220 initiates the contact (e.g., by polling) with the device user 260 via the user interface 230.

In accordance with that discussed above, the beta test manager 220 may additionally communicate with the developer/publisher 250 using the user interface 230, and vice versa. For example, the beta test manager 220 may communicate the reporting and diagnostic information received from the device user 260 to the developer/publisher 250, for example using the user interface 230. Alternatively, the developer/publisher 250 may communicate any predetermined guidelines for the deployment of the beta application to the beta test manager 220, again using the user interface 230. Likewise, the developer/publisher 250 may include beta applications in the application reservoir 210 using the user interface 230. Greater detail regarding the functions of the beta test manager 220 may be found above.

FIG. 3 illustrates a flow diagram of an embodiment of a method of beta testing online distributed applications carried out according to the principles of the disclosure. The method for beta testing online distributed applications begins in a start step 310 and continues on to step 320 wherein a beta application to be tested is received. For example, the beta application to be tested could be received from a developer/publisher using a user interface of the online application distribution system.

In a step 330, potential participants for beta testing the beta application may be determined. Again, as discussed in great detail above, the beta test manager has a role in determining the potential participants for the beta testing. In one embodiment, a request may be received to download a non-beta version of the beta application. In this embodiment, the potential participants are determined based upon the request received. In other embodiments, the step of determining potential participants includes polling for participants over the communications network. The polling, without limitation, may be of existing users of the non-beta application, users that have indicated a willingness to test beta applications, etc.

Thereafter, in a step 340, the beta application is sent over a communications network to at least one beta tester for beta testing, wherein the at least one beta tester is one of the potential participants. As discussed above, the beta application may be sent to the potential participants based upon predetermined guidelines. For example, these guidelines may be set by the developer/publisher.

The method for beta testing may also include receiving reporting and diagnostic information about the beta application from at least one participant. As discussed in great detail above, the amount and quality of reporting and diagnostic information that may be obtained is significant, and may include both automatically generated and well as user input reporting and diagnostic information.

The method for beta testing may additionally include terminating the beta testing--that is after one or more potential participants have received the beta application. This termination may be on a participant by participant basis, or as a whole, and regardless of whether it is being initiated by the participant or the developer/publisher. For example, the developer/publisher could terminate the beta testing, among other reasons, because a beta test time period has run, all issues have been collected and addressed, or even if a new beta version has been developed. Additionally, the participants could terminate the beta testing, as least with regard to themselves, if they are unhappy with the beta application, wish to roll back to the previous version, etc. In this embodiment, the participant might be sent a non-beta version of the beta application as part of the termination process. The method for beta testing would stop in an end step 350.

Those skilled in the art to which this application relates will appreciate that other and further additions, deletions, substitutions and modifications may be made to the described embodiments.

What is claimed is:

1. An online application distribution system, comprising:
an application reservoir; and
a beta test manager configured to determine if a user associated with the system will participate in beta testing for a beta application in the application reservoir.

2. The online application distribution system of claim 1, further including a user interface coupled to the beta test manager, wherein the user interface is configured to receive requests from the user to download the beta application from the application reservoir.

3. The online application distribution system of claim 1, further including a user interface coupled to the beta test manager, wherein the user interface is configured to transmit requests to the user to download the beta application from the application reservoir.

4. The online application distribution system of claim 1, wherein the beta test manager is configured to receive reporting and diagnostic information about the beta application from the user.

5. The online application distribution system of claim 4, wherein the beta test manager is configured to transmit at least a portion of the reporting and diagnostic information to a publisher of the beta application.

6. The online application distribution system of claim 4, wherein the beta test manager receives automatically generated reporting and diagnostic information.

7. The online application distribution system of claim 1, wherein the beta test manager is configured to terminate the beta testing for the at least one beta tester upon receiving a request to opt out of the beta testing, and send a non-beta version of the beta application thereto in response to the opt out request.

8. The online application distribution system of claim 1, wherein a publisher of the beta application can configure the beta test manager to distribute the beta application based upon predetermined guidelines.

9. The online application distribution system of claim 8, wherein the predetermined guidelines are selected from the group consisting of:
a number of overall downloads for the beta application;
device characteristics of a user device; and
duration of deployment of the beta testing.

10. The online application distribution system of claim 1 wherein the beta test manager enables the user to opt in to the beta testing on a per application basis.

11. A method of beta testing online distributed applications, comprising:
receiving a beta application to be tested;
determining potential participants for beta testing the beta application; and
sending the beta application over a communications network to at least one beta tester for beta testing, wherein the at least one beta tester is one of the potential participants.

12. The method of beta testing online distributed applications as recited in claim 11 further comprising receiving requests to download a non-beta version of the beta application.

13. The method of beta testing online distributed applications as recited in claim 12 wherein determining the potential participants is based on the requests received.

14. The method of beta testing online distributed applications as recited in claim 11 wherein determining potential participants includes proactively polling for the potential participants over the communications network.

15. The method of beta testing online distributed applications as recited in claim 11 further comprising terminating the beta testing based on testing parameters of the beta testing.

16. The method of beta testing online distributed applications as recited in claim 11 further comprising terminating the beta testing for the at least one beta tester upon receiving a request to opt out of the beta testing and sending a non-beta version of the beta application thereto is response to the opt out request.

17. The method of beta testing online distributed applications as recited in claim 11 further comprising receiving reporting and diagnostic information about the beta application from the at least one beta tester.

18. The method of beta testing online distributed applications as recited in claim 17, wherein the reporting and diagnostic information is automatically generated reporting and diagnostic information or user input reporting and diagnostic information.

19. The method of beta testing online distributed applications as recited in claim 11 wherein sending the beta application is based upon predetermined guidelines.

20. A computer-usable medium having non-transitory computer readable instructions stored thereon for execution by a processor to perform a method for beta testing online applications that are distributed over a communications network, the method comprising:
determining potential participants for beta testing a beta application that is stored in an application reservoir;
distributing the beta application over a communications network to at least one beta tester for the beta testing, wherein the at least one beta tester is one of the potential participants; and
receiving reporting and diagnostic information about performance of the beta application.
